(19) United States
(12) Patent Application Publication
(10) Pub. No.: US 2014/0118131 A1
(43) Pub. Date: May 1, 2014

(54) MONITORING AND WARNING SYSTEM FOR VEHICLES

(71) Applicant: PixArt Imaging Inc., Hsin-Chu County (TW)

(72) Inventors: Liang-Chi CHIU, Hsin-Chu (TW); Yu-Han CHEN, Hsin-Chu (TW); Ming-Tsan KAO, Hsin-Chu (TW)

(73) Assignee: PixArt Imaging Inc., Hsin-Chu County (TW)

(21) Appl. No.: 14/054,702

(22) Filed: Oct. 15, 2013

(30) Foreign Application Priority Data
Oct. 30, 2012 (TW) 101140044

(51) Int. Cl. B60Q 9/00; B60K 28/06

(52) U.S. Cl. CPC B60Q 9/008; B60K 28/066
USPC 340/435; 340/439

(57) ABSTRACT

There is provided a monitoring and warning system for vehicles including a first image sensor, a second image sensor, a warning unit, an expression recognition unit and a sign recognition unit. The first image sensor captures a first image frame toward a driver seat direction. The second image sensor captures a second image frame toward a forward direction. The expression recognition unit recognizes a sleep expression according to the first image frame to accordingly control the warning unit to trigger a first warning. The sign recognition unit recognizes a stop sign according to the second image frame to accordingly control the warning unit to trigger a second warning.

### CROSS REFERENCE TO RELATED APPLICATION

This application claims the priority benefit of Taiwan Patent Application Serial Number 101140044, filed on Oct. 30, 2012, the full disclosure of which is incorporated herein by reference.

### BACKGROUND

1. Field of the Disclosure

This disclosure generally relates to a vehicle control system and, more particularly, to a monitoring and warning system for vehicles that may monitor the traffic sign and the user spiritual state and give a warning when necessary.

2. Description of the Related Art

The purpose of the intelligent vehicle control system is to improve the driving comfort and the driving safety, e.g. by adjusting the seat position and air conditioner output and performing the human detection. In order to further improve the driving safety, it is further desired to remind the driver about the road condition ahead and his/her spiritual state.

The conventional sleep detection device is to detect the blinking speed of a driver to accordingly identify whether the driver is sleepy. However, in order to identify the blinking speed, the image sensor having a high frame rate has to be utilized such that more system resources are occupied and higher power is consumed.

At the present day the face recognition may be performed according to a single image frame captured by an image sensor based on the characteristic data obtained in the previous training. Accordingly, the frame rate of the image sensor can be significantly decreased, and if the face image is divided into a plurality of blocks and features of each block are analyzed, the facial expression recognition can be performed. For example, U.S. Patent Publication No. 2012169895 discloses a method and apparatus for capturing facial expressions employing the Hierarchical Temporal Memory (HTM) based recognizer that can recognize an object image to obtain a facial expression state and can be applied to image capturing devices such as the digital camera, Web camera, IP camera, monitoring camera or the like.

Accordingly, the present disclosure further provides a monitoring and warning system for vehicles that utilizes the object recognition technique to perform the traffic signal recognition and the expression recognition and may remind the driver when necessary so as to increase the driving safety.

### SUMMARY

The present disclosure provides a monitoring and warning system for vehicles that may monitor a traffic sign and remind the driver to slow down the speed or automatically slow down the speed when recognizing a stop sign generated by the traffic sign.

The present disclosure further provides a monitoring and warning system for vehicles that may monitor a user expression and remind the driver to concentrate when recognizing a sleep expression.

The present disclosure further provides a monitoring and warning system for vehicles that may simultaneously monitor a traffic sign and a user expression and give a warning when necessary so as to increase the driving safety.

The present disclosure provides a monitoring and warning system for vehicles including an image sensor, a warning unit and a sign recognition unit. The image sensor is configured to capture an image frame toward a forward direction. The warning unit is configured to trigger a warning. The sign recognition unit is configured to recognize a stop sign according to the image frame to accordingly control the warning unit to trigger the warning.

The present disclosure further provides a monitoring and warning system for vehicles including an image sensor, a warning unit and an expression recognition unit. The image sensor is configured to capture an image frame toward a driver seat direction. The warning unit is configured to trigger a warning. The expression recognition unit is configured to recognize a sleep expression according to the image frame to accordingly control the warning unit to trigger the warning.

The present disclosure further provides a monitoring and warning system for vehicles including a first image sensor, a second image sensor, a warning unit, an expression recognition unit and a sign recognition unit. The first image sensor is configured to capture a first image frame toward a driver seat direction. The second image sensor is configured to capture a second image frame toward a forward direction. The warning unit is configured to trigger a first warning and a second warning. The expression recognition unit is configured to recognize a sleep expression according to the first image frame to accordingly control the warning unit to trigger the first warning. The sign recognition unit is configured to recognize a stop sign according to the second image frame to accordingly control the warning unit to trigger the second warning.

In one aspect, the warning unit may trigger the first warning through a lamp signal, an image, a sound, a vibration and/or a current stimulation, and may trigger the second warning through a lamp signal, an image and/or a sound.

In one aspect, the sign recognition unit may further detect a power output of a dynamic system. When the sign recognition unit has recognized the stop sign and detects that the power output is decreasing, the warning unit is not controlled to trigger the second warning; whereas when the sign recognition unit has recognized the stop sign and detects that the power output is not decreasing, the warning unit is controlled to trigger the second warning.

In one aspect, the sign recognition unit may further detect a power output of a dynamic system. When the sign recognition unit has recognized the stop sign and detects that the power output is not decreasing, the sign recognition unit actively controls the dynamic system to decrease the power output or restrains the power output from increasing.

In one aspect, the sign recognition unit may identify a traffic sign of interest in a plurality of traffic signs according to the sign information saved in a memory unit. The expression recognition unit may further identify whether there is a driver in an image frame.

In the monitoring and warning system for vehicles according to the embodiment of the present disclosure, when the sign recognition unit has recognized a stop sign, it is able to detect whether a power output is gradually decreasing at first so as to determine whether to warn the driver or it is able to directly control a warning unit to give a warning. When the expression recognition unit identifies that a driver is contained in an image frame, the expression recognition unit starts to recognize the sleep expression of the driver immediately or after a predetermined time interval.

### BRIEF DESCRIPTION OF THE DRAWINGS

Other objects, advantages, and novel features of the present disclosure will become more apparent from the following detailed description when taken in conjunction with the accompanying drawings.

FIG. 1 shows an application schematic diagram of the monitoring and warning system for vehicles according to an embodiment of the present disclosure.

FIG. 2 shows a schematic block diagram of the monitoring and warning system for vehicles according to a first embodiment of the present disclosure.

FIG. 3 shows a schematic block diagram of the monitoring and warning system for vehicles according to a second embodiment of the present disclosure.

FIG. 4 shows a schematic block diagram of the monitoring and warning system for vehicles according to a third embodiment of the present disclosure.

### DETAILED DESCRIPTION OF THE EMBODIMENT

It should be noted that, wherever possible, the same reference numbers will be used throughout the drawings to refer to the same or like parts.

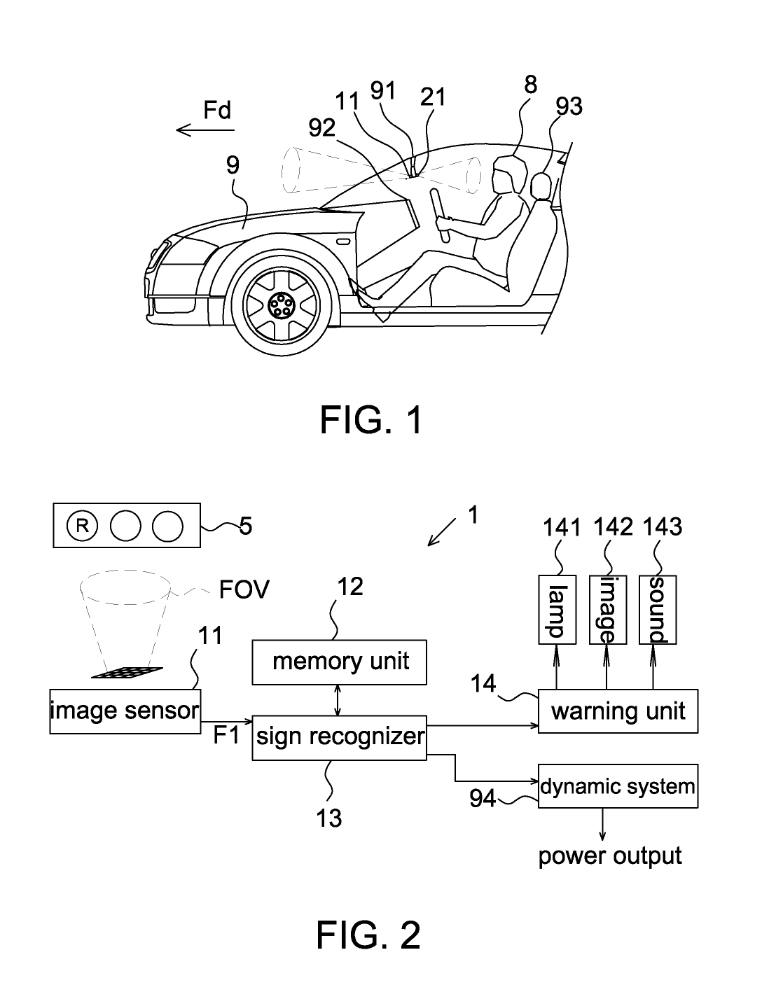

Referring to FIG. 1, it shows an application schematic diagram of the monitoring and warning system for vehicles according to an embodiment of the present disclosure. The monitoring and warning system for vehicles according to the embodiment of the present disclosure may be coupled to or integrated in the central control system of a vehicle 9 and coupled to the dynamic system thereof. The sign recognition algorithm and sign information may be built in the monitoring and warning system for vehicles according to the embodiment of the present disclosure such that the system may give a warning to a driver, force the power output to be decreased or restrain the power output from increasing according to the stop sign of traffic signs. For example in one embodiment, the power output may be gradually decreased with a predetermined rate till the driver notices or till the break is triggered so as to prevent accidents from an emergency break. In another embodiment, the acceleration may be suppressed by suppressing the power output so as to attract the attention of the driver. The expression recognition algorithm and expression information may be built in the monitoring and warning system for vehicles according to the embodiment of the present disclosure such that the system may give a warning to a driver according to the sleep expression of the driver. Accordingly, it is able to construct an intelligent vehicle control system to increase the driving safety. In addition, FIG. 1 only shows a part of elements of the vehicle 9, e.g. a rear-view mirror 91, a central control panel 92 and a driver seat 93 and other elements are omitted. In one embodiment, the sign recognition algorithm and the expression recognition algorithm may use the same algorithm but different feature information so as to perform the recognition of different objects. In other embodiments, it is possible to adopt different algorithms.

Referring to FIG. 2, it shows a schematic block diagram of the monitoring and warning system for vehicles 1 according to a first embodiment of the present disclosure. The monitoring and warning system for vehicles 1 according to the first embodiment of the present disclosure may include an image sensor 11, a memory unit 12, a sign recognition unit 13 and a warning unit 14, and may be coupled to a dynamic system 94 of a vehicle 9.

Referring to FIGS. 1 and 2, the monitoring and warning system for vehicles 1 according to the first embodiment of the present disclosure is described below.

The image sensor 11 may be a CCD image sensor, a CMOS image sensor or the like, and is configured to capture an image frame F1 toward a forward direction Fd of the vehicle 9, and thus the image sensor 11 is preferably disposed on a rear-view mirror 91, e.g. the image sensor 11 shown in FIG. 1. However, the image sensor 11 is not limited to be disposed on the rear-view mirror 91 and may be disposed at other positions without any limitation as long as it is able to capture images of the traffic sign 5 in front of the vehicle 9.

The memory unit 12 previously saves sign information associated with traffic signs and stop sings. As the monitoring and warning system for vehicles 1 according to the first embodiment of the present disclosure is configured to detect the stop sign, the sign information saved in the memory unit 12 may be the shape feature of the traffic sign 5 and position information of the stop sign at the traffic sign 5. For example, the stop sign (e.g. red light) may locate at the most left or top position of the traffic sign 5.

The sign recognition unit 13 may recognize a traffic sign 5 according to the image frame F1 and control the warning unit 14 to trigger a warning according to a stop sign. The sign recognition unit 13 may be implemented by a digital signal processor (DSP) or other processors capable of processing digital image data. After receiving the image frame F1, the sign recognition unit 13 utilizes the built-in algorithm to calculate the object feature in the image frame F1 and compares the object feature with the sign features previously saved in the memory unit 12 so as to recognize the traffic sign 5. Next, the sign recognition unit 13 may identify the stop sign according to the position that is lighting currently (e.g. the most left or top). In addition, the sign recognition unit 13 may further recognize a traffic sign of interest in a plurality of traffic signs. For example, when the sign recognition unit 13 recognizes a plurality of traffic signs according to the comparison result of the object feature and the sign features, the closest traffic sign in the plurality of traffic signs may be served as the traffic sign of interest, wherein the term “closest” may be identified according to values of the size, contrast and/or sharpness of the traffic sign.

The warning unit 14 is controlled by the sign recognition unit 13 to trigger a warning, wherein the warning unit 14 may trigger the warning through a lamp signal 141, an image 142 and/or a sound 143. The lamp signal 141 may be generated at any position inside the vehicle 9 within a view range of the driver 8;

the image 142 may be the picture shown by a liquid crystal display or other displays that are, for example, integrated with the central control panel 92; and the sound 143 may be generated by the vehicle radio or additionally speaker. It is appreciated that the disposition and generation of the above lamp signal 141, image 142 and sound 143 are only intended to describe the present disclosure, not to limit the present disclosure.

In the present disclosure, the sign recognition unit 13 may further be configured to detect a power output of a dynamic system 94 of the vehicle 9. In one embodiment, when the sign recognition unit 13 has recognized the stop sign and detects that the power output is decreasing (e.g. decreasing at a predetermined rate within each predetermined time interval), the warning unit 14 is not controlled to trigger the warning. When the sign recognition unit 13 has recognized the stop sign and detects that the power output is not decreasing, the warning unit 14 is controlled to trigger the warning so as to warn the driver 8 to break or release the accelerator. In another embodiment, when the sign recognition unit 13 has recognized the stop sign and detects that the power output is not decreasing, the sign recognition unit 13 actively controls the dynamic system 94 to decrease the power output or restrains the power output from increasing thereby increasing the driving safety. In an alternative embodiment, when the sign recognition unit 13 has recognized the stop sign, the sign recognition unit 13 immediately controls the warning unit 14 to trigger the warning to warn the driver 8 to brake or release the accelerator regardless of the current driving condition.

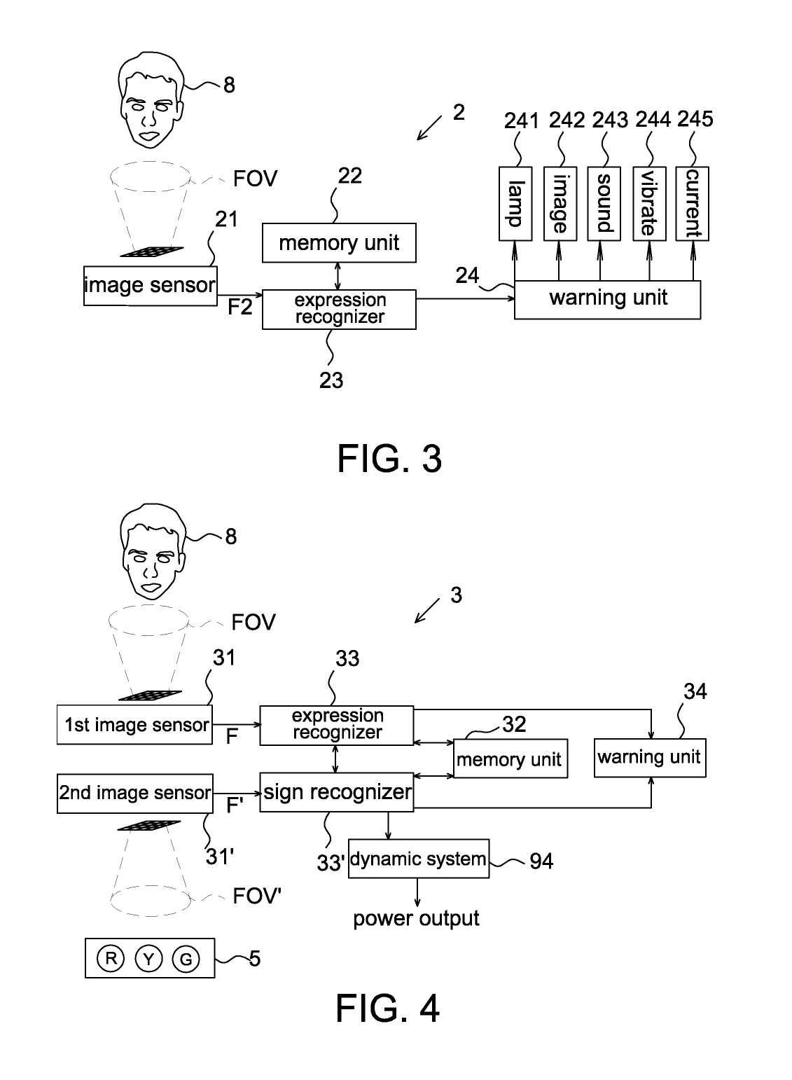

Referring to FIG. 3, it shows a schematic block diagram of the monitoring and warning system for vehicles 2 according to a second embodiment of the present disclosure. The monitoring and warning system for vehicles 2 according to the second embodiment of the present disclosure may include an image sensor 21, a memory unit 22, an expression recognition unit 23 and a warning unit 24.

Referring to FIGS. 1 and 3 together, the monitoring and warning system for vehicles 2 according to the second embodiment of the present disclosure is described hereinafter.

The image sensor 11 may also be a CCD image sensor, a CMOS sensor or the like, and is configured to capture an image frame F2 toward a driver seat direction of a driver seat 93, and thus the image sensor 21 is preferably disposed on a rear-view minor 91, e.g. the image sensor 21 shown in FIG. 2. However, the image sensor 21 is not limited to be disposed on the rear-view mirror 91 and may be disposed at other positions without any limitation as long as it is able to capture face images of the driver 8.

The memory unit 22 previously saves expression information associated with the sleep expression. For example, an expression recognition algorithm may divide a face image into a plurality of blocks and calculate the feature of every block associated with the sleep expression to be previously recorded. In other embodiments, if the expression recognition unit 23 may further recognize other expressions or perform the ID identification, the memory unit 22 may also save the related expression information or facial information.

The expression recognition unit 23 is configured to recognize a sleep expression according to the image frame F2 to accordingly control the warning unit 22 to trigger a warning. The expression recognition unit 23 may be implemented by a digital signal processor or other processors capable of processing digital image data. After receiving the image frame F2, the expression recognition unit 23 utilizes the built-in algorithm to calculate the expression feature in the image frame F2 and compares the expression feature with the expression features previously saved in the memory unit 12 so as to recognize the sleep expression. In addition, the expression recognition unit 23 may further identify whether there is a driver 8 in the image frame F2. In one embodiment, when the expression recognition unit 23 identifies that a driver 8 is contained in the image frame F2, the expression recognition unit 23 starts to recognize the sleep expression of the driver 8 immediately or after a predetermined time interval, wherein the predetermined time interval may be, but not limited to, 30 minutes or an hour, or it may be set by the user.

The warning unit 14 is controlled by the expression recognition unit 23 to trigger a warning, wherein the warning unit 14 may trigger the warning through a lamp signal 241, an image 242, a sound 243, a vibration 244 and/or a current stimulation 245. The lamp signal 241 may be generated at any position inside the vehicle 9 within a view range of the driver 8; the image 242 may be the picture shown by a liquid crystal display or other displays that are, for example, integrated with the central control panel 92; the sound 243 may be generated by the vehicle radio or additionally speaker; the vibration 244 and the current stimulation 245 may be transmitted to the driver 8 through, for example, the driver seat 93. It is appreciated that the disposition and generation of the above lamp signal 241, image 242, sound 243, vibration 244 and current stimulation 245 are only intended to describe the present disclosure, not to limit the present disclosure.

Referring to FIG. 4, it shows a schematic block diagram of the monitoring and warning system for vehicles 3 according to a third embodiment of the present disclosure. The monitoring and warning system for vehicles 3 according to the third embodiment of the present disclosure may simultaneously recognize a traffic sign, a stop sign and a sleep expression. The monitoring and warning system for vehicles 3 includes a first image sensor 31, a second image sensor 31′, a memory unit 32, an expression recognition unit 33, a sign recognition unit 33′ and a warning unit 34, and may be coupled to a dynamic system 94 of a vehicle 9. In this embodiment, the first image sensor 31 and the expression recognition unit 33 may respectively correspond to the image sensor 21 and the expression recognition unit 23 in the second embodiment; and the second image sensor 31′ and the sign recognition unit 33′ may respectively correspond to the image sensor 11 and the sign recognition unit 13 in the first embodiment. The memory unit 32 may save the expression information associated with sleep expressions and the sign information associated with traffic signs and stop signs. Therefore, the first image sensor 31 is preferably disposed on a rear-view mirror 91, e.g. at the position 21; and the second image sensor 31′ is preferably also disposed on the rear-view mirror 91, e.g. at the position 11, but not limited to.

Similar to the second embodiment, in this embodiment the first image sensor 31 is configured to capture a first image frame F toward a driver seat direction of the driver seat 93. The expression recognition unit 33 is configured to recognize a sleep expression according to the first image frame F to accordingly control the warning unit 34 to trigger a first warning. Similarly, the warning unit 34 may trigger the first warning through a lamp signal, an image, a sound, a vibration and/or a current stimulation. In addition, the expression recognition unit 33 may further identify whether there is a driver 8 in the first image frame F. In addition, the method of recognizing a sleep expression according to the first image frame F captured by the first image sensor 31 and controlling the warning unit 34 to trigger the first warning is similar to the aforementioned second embodiment and thus details thereof are not repeated herein.

Similar to the first embodiment, in this embodiment the second image sensor 31′ is configured to capture a second image frame F′ toward a forward direction Fd of the vehicle 9. The sign recognition unit 33′ is configured to recognize a traffic sign 5 according to the second image frame F′ and controls the warning unit 34 to trigger a second warning according to a stop sign of the traffic sign 5. Similarly, the warning unit 34 may trigger the second warning through a lamp signal, an image and/or a sound. In addition, the sign recognition unit 33′ may identify a traffic sign of interest in a plurality of traffic signs and further recognize the stop sign (e.g. red light) generated by the traffic sign of interest.

In addition, the sign recognition unit 33′ may further detect a power output of a dynamic system 94 of the vehicle 9. In one embodiment, when the sign recognition unit 33′ has recognized the stop sign and detects that the power output is decreasing, the warning unit 34 is not controlled to trigger the second warning. When the sign recognition unit 33′ has recognized the stop sign and detects that the power output is not decreasing, the warning unit 34 is controlled to trigger the second warning so as to warn the driver 8 to break or release the accelerator. In another embodiment, when the sign recognition unit 33′ has recognized the stop sign and detects that the power output is not decreasing, the sign recognition unit 33′ actively controls the dynamic system 94 to decrease the power output thereof or restrains the power output from increasing thereby increasing the driving safety. In an alternative embodiment, when the sign recognition unit 33′ has recognized the stop sign, the sign recognition unit 33′ immediately controls the warning unit 34 to trigger the second warning to warn the driver 8 to brake or release the accelerator regardless of the current driving condition.

In addition, the method of recognizing a stop sign according to the second image frame F′ captured by the second image sensor 31′ and controlling the warning unit 34 to trigger the second warning and/or to change the power output is similar to the aforementioned first embodiment and thus details thereof are not repeated herein.

In one embodiment, the expression recognition unit 33 and the sign recognition unit 33′ may be implemented by a single digital processor. That is, the expression recognition unit 33 and the sign recognition unit 33′ may be implemented by a single element or by two elements.

It is appreciated that the above traffic sign 5 is only exemplary, and the traffic sign 5 may be other types, e.g. lamps arranged in a vertical line. The sign information of different types of traffic signs may be previously saved in the memory units 12 and 32.

In addition, in FIGS. 2-4 the symbols “FOV” and “FOV'” are referred to the field of view of the image sensors.

In addition, the monitoring and warning system for vehicles 1-3 according to the embodiment of the present disclosure may cooperate with the ID identification system. For example, the expression recognition units 23 and 33 may be configured to identify a user ID so to as further increase the practicality thereof.

As mentioned above, the conventional sleep detection device is mainly configured to detect the blinking speed and needs to capture images at a higher frame rate. Therefore, the present disclosure further provides a monitoring and warning system for vehicles (FIGS. 2-4) that may simultaneously detect a stop traffic sign and a sleep expression to accordingly warn the driver to decrease the power output or to concentrate thereby broadening the application of the vehicle control system. And since the present disclosure may detect the sleep expression according to a single image, the frame rate of the image sensor is decreased.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A monitoring and warning system for vehicles, comprising:
an image sensor configured to capture an image frame toward a forward direction;
a warning unit configured to trigger a warning; and
a sign recognition unit configured to recognize a stop sign according to the image frame to accordingly control the warning unit to trigger the warning.

2. The monitoring and warning system as claimed in claim 1, wherein the warning unit triggers the warning through at least one of a lamp signal, an image and a sound.

3. The monitoring and warning system as claimed in claim 1, wherein the sign recognition unit is further configured to detect a power output of a dynamic system.

4. The monitoring and warning system as claimed in claim 3, wherein when the sign recognition unit has recognized the stop sign and detects the power output is decreasing, the warning unit is not controlled to trigger the warning; and when the sign recognition unit has recognized the stop sign and detects the power output is not decreasing, the warning unit is controlled to trigger the warning.

5. The monitoring and warning system as claimed in claim 3, wherein when the sign recognition unit has recognized the stop sign and detects the power output is not decreasing, the sign recognition unit controls the dynamic system to decrease the power output or restrains the power output from increasing.

6. The monitoring and warning system as claimed in claim 1, further comprising a memory unit configured to save sign information associated with traffic signs and the stop sign.

7. The monitoring and warning system as claimed in claim 6, wherein the sign recognition unit is further configured to recognize a traffic sign of interest in a plurality of traffic signs according to the sign information.

8. A monitoring and warning system for vehicles, comprising:
an image sensor configured to capture an image frame toward a driver seat direction;
a warning unit configured to trigger a warning; and
an expression recognition unit configured to recognize a sleep expression according to the image frame to accordingly control the warning unit to trigger the warning.

9. The monitoring and warning system as claimed in claim 8, wherein the warning unit triggers the warning through at least one of a lamp signal, an image, a sound, a vibration and a current stimulation.

10. The monitoring and warning system as claimed in claim 8, wherein the expression recognition unit is further configured to identify whether there is a driver in the image frame.

11. The monitoring and warning system as claimed in claim 10, wherein when identifying there is a driver in the image frame, the expression recognition unit starts to recognize the sleep expression immediately or after a predetermined time interval.

12. The monitoring and warning system as claimed in claim 8, further comprising a memory unit configured to save expression information associated with the sleep expression.

13. A monitoring and warning system for vehicles, comprising:
a first image sensor configured to capture a first image frame toward a driver seat direction;
a second image sensor configured to capture a second image frame toward a forward direction;
a warning unit configured to trigger a first warning and a second warning;
an expression recognition unit configured to recognize a sleep expression according to the first image frame to accordingly control the warning unit to trigger the first warning; and
a sign recognition unit configured to recognize a stop sign according to the second image frame to accordingly control the warning unit to trigger the second warning.

14. The monitoring and warning system as claimed in claim 13, wherein the warning unit triggers the first warning through at least one of a lamp signal, an image, a sound, a vibration and a current stimulation, and triggers the second warning through at least one of a lamp signal, an image and a sound.

15. The monitoring and warning system as claimed in claim 13, wherein the sign recognition unit is further configured to detect a power output of a dynamic system.

16. The monitoring and warning system as claimed in claim 15, wherein when the sign recognition unit has recognized the stop sign and detects the power output is decreasing, the warning unit is not controlled to trigger the second warning; and when the sign recognition unit has recognized the stop sign and detects the power output is not decreasing, the warning unit is controlled to trigger the second warning.

17. The monitoring and warning system as claimed in claim 15, wherein when the sign recognition unit has recognized the stop sign and detects the power output is not decreasing, the sign recognition unit controls the dynamic system to decrease the power output or restrains the power output from increasing.

18. The monitoring and warning system as claimed in claim 13, further comprising a memory unit configured to save expression information associated with the sleep expression and sign information associated with traffic signs and the stop sign.

19. The monitoring and warning system as claimed in claim 13, wherein the expression recognition unit is further configured to identify whether there is a driver in the first image frame.

20. The monitoring and warning system as claimed in claim 13, wherein the first image sensor and the second image sensor are disposed on a rear-view mirror.
